(19) United States
(12) Patent Application Publication
(10) Pub. No.: US 2026/0055221 A1
(43) Pub. Date: Feb. 26, 2026

(54) THICKENING ALKYLATED COPOLYMER

(71) Applicant: COATEX, Genay (FR)

(72) Inventors: Laurie PARRENIN, Villeneuve (FR); Denis RUHLMANN, Genay (FR); Jean-Marc SUAU, Lucenay (FR)

(73) Assignee: COATEX, Genay (FR)

(21) Appl. No.: 18/847,542

(22) PCT Filed: Mar. 10, 2023
(86) PCT No.: PCT/FR2023/000024

§ 371 Date: Sep. 16, 2024

(30) Foreign Application Priority Data
Mar. 18, 2022 (FR) FR2202414

(51) Int. Cl. C08F 220/18; C09D 7/43; C09D 7/65; C09D 17/00

(52) U.S. Cl. CPC C08F 220/1802; C09D 7/43; C09D 7/65; C09D 17/001; C08F 2800/20; C08F 2810/20

(57) ABSTRACT

A thickening (meth)acrylic copolymer is disclosed. The thickening (meth)acrylic copolymer is prepared using a polyalkoxylated Guerbet alcohol comprising a double-branched alkyl group. A process for preparing the copolymer is also disclosed. The copolymer may be used in aqueous compositions, in particular in coating compositions, to maintain desired rheological properties such as viscosity.

The invention relates to a thickening (meth)acrylic copolymer prepared using a polyalkoxylated Guerbet alcohol comprising a double-branched alkyl group. The invention also relates to the process for preparing said copolymer and to the use thereof in aqueous compositions, in particular in coating compositions.

Many technical fields require the use of aqueous compositions. These include, in particular, aqueous hydraulic binder compositions, aqueous adhesive compositions, aqueous detergent compositions, aqueous cosmetic compositions, aqueous ink compositions, aqueous paper coating compositions, aqueous coating compositions, in particular aqueous varnish compositions or aqueous paint compositions, for example aqueous decorative paint compositions or aqueous industrial paint compositions. In addition to their functional properties, these aqueous compositions must have a texture adapted to their use or to their storage. In particular, they must have a suitable viscosity.

Moreover, it must be possible to use these aqueous compositions in conditions that can vary greatly. In particular, the viscosity of these aqueous compositions can change or degrade. The functional properties of these aqueous compositions can therefore be altered if their rheological behaviour is not adapted, for example to prevent settling or phase separation phenomena over the course of their storage, which can also appear as variations in viscosity. Such changes or degradations are particularly detrimental or damaging to aqueous hydraulic binder compositions, to aqueous adhesive compositions, to aqueous detergent compositions, to aqueous cosmetic compositions, to aqueous ink compositions, to aqueous paper coating compositions, to aqueous coating compositions, in particular to aqueous varnish or paint compositions.

There is therefore a need to be able to have aqueous compositions that do not have such disadvantages or aqueous compositions that do not lead to such problems.

In particular, it is especially useful to be able to have aqueous coating compositions, particularly aqueous varnish or paint compositions, whose viscosity is adapted to maintain both their homogeneity and the integrity of their functional properties. Maintaining the viscosity and limiting the loss of viscosity of these aqueous compositions should be possible for wide ranges of shear gradients.

As a result, many aqueous coating compositions use rheology-modifying polymers. These polymers should make it possible to impart the desired rheological properties to aqueous compositions over wide ranges of shear rates. These polymers should also improve shear thinning in these aqueous compositions by giving them sufficient pseudo-plastic behaviour, ensuring their stability and homogeneity over the course of their storage, facilitating their transfer to application tools and helping to limit the appearance of drips once they have been applied. The compatibility of the various constituents in an aqueous coating composition must also be considered. It is particularly important that the thickening copolymer and the pigments and binders used are suitably compatible.

It is also important to improve the pigment compatibility of aqueous coating compositions, particularly paint compositions and in particular with regard to the addition of pigment concentrates used for colouring. Without good pigment compatibility, the rheology of the composition can be severely degraded. Inadequate pigment compatibility can also lead to reduced colouring strength and result in an uneven or washed-out shade, which can lead to the use of a higher amount of pigment or to aesthetic flaws in the final coating.

Document WO 2011119363 describes an adhesive based on Guerbet alcohol (meth)acrylate. Document US2015329660 describes thickeners prepared in the presence of a non-polymerisable surfactant compound derived from a Guerbet alcohol. Document WO 2011130310 describes the use of a surfactant compound prepared with a Guerbet alcohol. Document WO 2011135039 describes the use of an associative vinyl copolymer. Document CA 2852651 describes a mixture of surfactant compounds prepared with Guerbet alcohols.

The known polymers used as thickening agents do not always provide a satisfactory solution to these different problems. There is therefore a need for improved rheology-modifying copolymers. The copolymer according to the invention makes it possible to provide a solution to all or part of the problems of the polymers in the prior art. Thus, the invention provides a copolymer P prepared by at least one polymerisation reaction:
of at least one anionic monomer (a) chosen among acrylic acid, an acrylic acid salt, methacrylic acid, a methacrylic acid salt and combinations thereof:
of at least one C₁-C₈ ester (b) of a compound derived from an acid chosen among acrylic acid, methacrylic acid, maleic acid, itaconic acid and crotonic acid:
of at least one compound (c) prepared by reaction:
   of at least one compound (d) obtained by:
      dimerisation, by a Guerbet reaction, of two identical or different compounds of formula I:

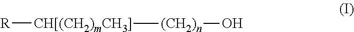

wherein:
   R independently represents a straight C₄-C₉-alkyl group:
   m independently represents 0 or 1:
   n independently represents a number ranging from 2 to 7; and
polyalkoxylation of the resulting dimer, and
of at least one compound (e) comprising a polymerisable group and another group reactive with the hydroxyl group of the compound (d).

Preferably for the copolymer P according to the invention, the anionic monomer (a) is chosen among acrylic acid, methacrylic acid and combinations thereof.

Also preferably for the copolymer P according to the invention, the ester (b) is a C₁-C₇ ester or a C₁-C₆ ester or a C₁-C₄ ester, preferably a C₁-C₃ ester. Also preferably for the copolymer P according to the invention, the ester (b) is an acrylic acid ester or a methacrylic acid ester, preferably an acrylic acid ester. In particular, the ester (b) is chosen among methyl acrylate, ethyl acrylate, propyl acrylate, butyl acrylate, ethyl hexyl acrylate, methyl methacrylate, ethyl methacrylate, propyl methacrylate, butyl methacrylate, ethyl hexyl methacrylate and combinations thereof. More preferentially, the ester (b) is chosen among ethyl acrylate, methyl acrylate, butyl acrylate, methyl methacrylate and combinations thereof.

Essentially according to the invention, the compound (d) is obtained by a dimerisation reaction of two compounds of formula I. This dimerisation is a Guerbet reaction carried out with these two alcohols of formula I. The dimerisation reaction and the conditions under which it is carried out are known per se. The Guerbet reaction is generally carried out at high temperature and pressure, in a basic medium and in the presence of a catalyst. The compound (d) can be prepared using the same compound of formula I or using two different compounds of formula I. The resulting dimer is treated so as to arrive at the polyalkoxylated compound (d).

Preferably according to the invention, the dimerisation of two identical compounds of formula I results in a homodimer (d1). Also preferably according to the invention, the compound (d) is a homodimer (d1) obtained by dimerisation of two identical compounds of formula I wherein:
R represents a straight C₅-C₇-alkyl group:
m represents 0 or 1, preferably 0;
n represents a number ranging from 2 to 7.

More preferably according to the invention, the compound (d) is a homodimer (d1) obtained by dimerisation of two identical compounds of formula I wherein:
R represents a straight C₄-C₉-alkyl group, preferably a straight C₅-C₇-alkyl group:
m represents 0 or 1, preferably 0;
n represents a number ranging from 5 to 7, preferably from 4 to 6, more preferentially 4 or 5.

Particularly preferably according to the invention, the dimerisation is carried out using two different compounds (d) of formula I and results in a mixture comprising 2 different homodimers (d1) and a heterodimer (d2). Preferably, this is a mixture consisting of 2 different homodimers (d1) and of a heterodimer (d2). Also preferably, a mixture of compounds (d) can be obtained by dimerisation of two different compounds of formula I wherein:
R independently represents a straight C₅-C₇-alkyl group:
m independently represents 0 or 1, preferably 0;
n independently represents a number ranging from 2 to 7.

Preferably according to the invention, a mixture of compounds (d) can be obtained by dimerisation of two different compounds of formula I wherein:
R independently represents a straight C₄-C₉-alkyl group, preferably a straight C₅-C₇-alkyl group;
m independently represents 0 or 1, preferably 0;
n independently represents a number ranging from 5 to 7, preferably from 4 to 6, more preferentially 4 or 5.

A preferred mixture of compounds (d) comprises a heterodimer compound (d2) obtained by dimerisation of a first compound of formula I wherein R represents a straight C₅-alkyl group, m represents 0 and n represents 5 and of a second different compound of formula I wherein R represents a straight C₇-alkyl group, m represents 0 and n represents 4. A particularly preferred mixture of compounds (d) comprises:
a heterodimer compound (d2) obtained by dimerisation of a first compound of formula I wherein R represents a straight C₅-alkyl group, m represents 0 and n represents 5 and of a second different compound of formula I wherein R represents a straight C₇-alkyl group, m represents 0 and n represents 4,
a first homodimer (d1) obtained by dimerisation of a compound of formula I wherein R represents a straight C₅-alkyl group, m represents 0 and n represents 5,
a second homodimer (d1) obtained by dimerisation of a different compound of formula I wherein R represents a straight C₇-alkyl group, m represents 0 and n represents 4. According to the invention, the dimerisation carried out using two different compounds of formula I can result in a mixture consisting of two different homodimers (d1) and of a heterodimer (d2).

According to the invention, the compound (d) is prepared by dimerisation of two compounds of formula I and polyalkoxylation of the resulting dimer. The polyalkoxylation reaction and the conditions under which it is carried out are known per se. Preferably for the copolymer P according to the invention, the compound (d) comprises from 10 to 150 alkoxylations. More preferentially, the compound (d) comprises from 20 to 10 to 100 alkoxylations or from 10 to 70 alkoxylations, more preferentially from 20 to 60 alkoxylations. Also preferably, the compound (d) is polyethoxylated or is polyethoxylated-polypropoxylated or is polyethoxylated-poly butoxylated: preferably the compound (d) is polyethoxylated. More preferably, the compound (d) is polyethoxylated.

Particularly preferably, the compound (d) comprises from 10 to 150 ethoxylations, more preferentially from 20 to 100 ethoxylations or from 10 to 70 ethoxylations, much more preferentially from 20 to 60 ethoxylations.

According to the invention, the compound (e) comprises a polymerisable group, preferably a terminal ethylene group, that is capable of reacting with the polymerisable groups of the compounds (a) and (b). Preferably according to the invention, the polymerisable group of the compound (e) is chosen among vinyl, allyl, methallyl, isoprenyl, styrylyl, acrylate, methacrylate, itaconate, maleate, crotonate.

Preferably according to the invention, the compound (e) can be chosen among acrylic acid, methacrylic acid, maleic acid, itaconic acid, crotonic acid, acrylic anhydride, methacrylic anhydride, maleic anhydride, itaconic anhydride, styrylyl-isocyanates (for example, 3-isopropenyl-α, α′-dimethylbenzyl isocyanate or TMI, CAS number 2094-99-7), acrylate-alkylene-isocyanates (for example, 2-isocyanatoethyl acrylate, CAS number 13641-96-8), methacrylate-alkylene-isocyanates (for example, 2-isocyanatoethyl methacrylate, CAS number 30674-80-7) and combinations thereof.

Also preferably according to the invention, the compound (e) can be prepared by prior reaction of a diisocyanate compound (for example tolyl diisocyanate, isophorone diisocyanate) and of at least one compound chosen among ethylene glycol acrylate, ethylene glycol methacrylate, isoprenol, ethylene glycol vinyl, allyl alcohol, methallyl alcohol, hydroxy butyl vinyl ether and combinations thereof.

More preferably according to the invention, the compound (e) is chosen among acrylic anhydride, methacrylic anhydride, 3-isopropenyl-α, α′-dimethylbenzyl isocyanate, 2-isocyanatoethyl acrylate, 2-isocyanatoethyl methacrylate, from a compound prepared by prior reaction of tolyl diisocyanate or of isophorone diisocyanate and of ethylene glycol methacrylate and combinations thereof.

When preparing the copolymer P according to the invention, the amounts of the compounds (a), (b) and (c) can vary. Preferably for the copolymer P, the polymerisation reaction uses:
from 20 to 74.9% by weight or from 25 to 69.5% by weight, preferably from 30 to 68% by weight or from 35 to 60% by weight, of monomer (a) or
from 25 to 79.9% by weight or from 30 to 74.5% by weight, preferably from 30 to 68% by weight or from 35 to 64.5% by weight, of monomer (b), or
from 0.1 to 55% by weight or from 0.5 to 45% by weight, preferably from 2 to 40% by weight or from 5 to 30% by weight, of monomer (c), relative to the total amount by weight of monomers (a), (b) and (c).

Also preferably according to the invention, the polymerisation reaction can use:
from 20 to 74.9% by weight of monomer (a),
from 25 to 79.9% by weight of monomer (b), and
from 0.1 to 55% by weight of monomer (c), relative to the total amount by weight of monomers (a), (b) and (c).

Also preferably according to the invention, the polymerisation reaction can use:
from 25 to 69.5% by weight of monomer (a),
from 30 to 74.5% by weight of monomer (b), and
from 0.5 to 45% by weight of monomer (c), relative to the total amount by weight of monomers (a), (b) and (c).

Also preferably according to the invention, the polymerisation reaction can use:
from 30 to 68% by weight of monomer (a),
from 30 to 68% by weight of monomer (b), and
from 2 to 40% by weight of monomer (c), relative to the total amount by weight of monomers (a), (b) and (c).

Also preferably according to the invention, the polymerisation reaction can use:
from 35 to 60% by weight of monomer (a),
from 35 to 64.5% by weight of monomer (b), and
from 5 to 30% by weight of monomer (c), relative to the total amount by weight of monomers (a), (b) and (c).

Also preferably for the copolymer P, the polymerisation reaction uses:
from 20 to 70% by weight or from 25 to 65% by weight, preferably from 30 to 65% by weight or from 35 to 60% by weight, of monomer (a) or
from 25 to 75% by weight or from 30 to 70% by weight, preferably from 30 to 65% by weight or from 35 to 60% by weight, of monomer (b), or
from 5 to 55% by weight or from 5 to 45% by weight, preferably from 5 to 40% by weight or from 5 to 30% by weight, of monomer (c), relative to the total amount by weight of monomers (a), (b) and (c).

More preferably for the copolymer P, the polymerisation reaction uses:
from 20 to 70% by weight or from 25 to 65% by weight, preferably from 30 to 65% by weight or from 35 to 60% by weight, of monomer (a),
from less than 25 to less than 75% by weight or from less than 30 to less than 70% by weight, preferably from less than 30 to less than 65% by weight or from less than 35 to less than 60% by weight, of monomer (b),
more than 5 to 55% by weight or more than 5 to 45% by weight, preferably more than 5 to 40% by weight or more than 5 to 30% by weight, of monomer (c), relative to the total amount by weight of monomers (a), (b) and (c).

Also more preferably for the copolymer P, the polymerisation reaction uses:
from 20 to 70% by weight or from 25 to 65% by weight, preferably from 30 to 65% by weight or from 35 to 60% by weight, of monomer (a),
from 24 to 74% by weight or from 29 to 69% by weight, preferably from 29 to 64% by weight or from 34 to 59% by weight, of monomer (b),
from 6 to 55% by weight or from 6 to 45% by weight, preferably from 6 to 40% by weight or from 6 to 30% by weight, of monomer (c), relative to the total amount by weight of monomers (a), (b) and (c).

Particularly preferably for the copolymer P, the polymerisation reaction uses:
from 50 to 70% by weight or from 05 to 65% by weight, of monomer (a),
from less than 25 to less than 45% by weight or from less than 30 to less than 40% by weight, of monomer (b),
more than 5 to 55% by weight or more than 5 to 45% by weight, of monomer (c), relative to the total amount by weight of monomers (a), (b) and (c).

Also particularly preferably for the copolymer P, the polymerisation reaction uses:
from 50 to 70% by weight or from 50 to 65% by weight, of monomer (a),
from 24 to 44% by weight or from 29 to 39% by weight, of monomer (b),
from 6 to 55% by weight or from 6 to 45% by weight, of monomer (c), relative to the total amount by weight of monomers (a), (b) and (c).

Particularly preferably for the copolymer P, the polymerisation reaction uses more than 5% by weight, preferably more than 6% by weight or more than 8% by weight, of monomer (c) relative to the total amount by weight of monomers (a), (b) and (c). Also particularly preferably for the copolymer P, the polymerisation reaction uses more than 50% by weight or more than 55% by weight of monomer (a) relative to the total amount by weight of monomers (a), (b) and (c).

According to the invention, the polymerisation reaction can use only compounds (a), (b) and (c) or use one or more other additional compounds. Thus, the polymerisation reaction can also use at least one cross-linking monomer (f) or at least one monomer (f) comprising at least two olefinic unsaturations, preferably less than 5% by weight, preferably from 0.01 to 4% by weight, in particular from 0.02 to 4% by weight or from 0.02 to 2% by weight, particularly from 0.02 to 1% by weight, of monomer (f) relative to the total amount by weight of monomers.

According to the invention, the polymerisation reaction can also use at least one hydrophobic monomer (g) different from compound (c), preferably chosen among a compound of formula (II):

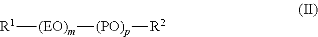

wherein:
m and p, identical or different, independently represent 0 or an integer or decimal less than 150, m or p is different from 0,
EO independently represents a CH₂CH₂O group,
PO independently represents a group chosen among CH(CH₃) CH₂O and CH₂CH(CH₃) O,
R¹ independently represents a group comprising at least one polymerisable olefinic unsaturation, preferably an acrylate group or a methacry late group and
R² independently represents a straight or branched C₆-C₄₀-alkyl group, a phenyl group, a polyphenyl group, preferably a straight or branched C₁₀-C₃₀-alkyl group, more preferentially a straight or branched C₁₂-C₂₂-alkyl group, or a group comprising 2 to 5 phenyls or a tristyrylphenyl group or a pentastyrylcumylphenyl group, preferably less than 20% by weight, preferably from 0.05 to 20% by weight, particularly from 0.1 to 10% by weight, of monomer (g) relative to the total amount by weight of monomers.

More preferably, the polymerisation reaction can use at least one compound (h) chosen among 2-acrylamido-2-methylpropane sulphonic acid, ethoxymethacrylate sulphonic acid, sodium methallyl sulphonate, styrene sulphonate hydroxyethyl acrylate phosphate, hydroxypropyl acrylate phosphate, hydroxyethylhexyl acrylate phosphate, hydroxyethyl methacrylate phosphate, hydroxypropyl methacrylate phosphate, hydroxyethylhexyl methacry late phosphate, their salts and combinations thereof, preferably less than 20% by weight, preferably from 0.2% to 20% by weight, in particular from 0.5% to 10% by weight, of monomer (h) relative to the total amount by weight of monomers.

Also preferably, the polymerisation reaction can use at least one compound (i) chosen among hydroxyethyl acrylate, hydroxypropyl acrylate, hydroxyethylhexyl acrylate, hydroxyethyl methacrylate, hydroxypropyl methacrylate, hydroxyethylhexyl methacrylate, preferably less than 20% by weight, preferably from 0.2 to 20% by weight, in particular from 0.5 to 10% by weight, of monomer (i) relative to the total amount by weight of monomers.

Advantageously according to the invention, the polymerisation reaction does not use amides or amide derivatives or does not use hydroxyethyl (meth)acrylate or hydroxypropyl (meth)acrylate.

According to the invention, the copolymer P can be used as is, in acid form, or it can be fully or partially neutralised or coacervated. Preferably, the copolymer P can be fully or partially neutralised, preferably by means of at least one compound chosen among NaOH, KOH, ammonium derivatives, ammonia, amine bases, for example triethanolamine, aminomethylpropanol or 2-amino-2-methyl-propanol (AMP) and combinations thereof. Also preferably, the copolymer P can be fully or partially coacervated, preferably by reducing the pH, for example by reducing the pH to below 6.5, or by increasing the ionic strength. The pH can be reduced by means of an acid compound, in particular by means of least one organic or inorganic acid compound, in particular an acid compound chosen among phosphoric acid, citric acid, glucono-lactone, lactic acid, salicylic acid, glycolic acid, ascorbic acid, glutamic acid, hydrochloric acid, acetic acid, D-gluconic acid, sulphonic acid, methanesulphonic acid, benzimidazole sulphonic acid, tartaric acid, 4-aminobenzoic acid, benzoic acid, sorbic acid, phenyl benzimidazole sulphonic acid, benzylidene camphor sulphonic acid, terephthalylidene dicamphor sulphonic acid, kojic acid, hyaluronic acid. The ionic strength can be increased by adding at least one ionised compound or at least one salt, in particular NaCl, KCl, MgCl₂, CaCl₂), MgSO₄, CaSO₄, or by adding phenylbenzimidazole sulphonic acid (PBSA) or pyroglutamic acid sodium salt (NaPCA) or even by adding at least one ionised organic sun filter.

Generally according to the invention, when dissolved in water the copolymer P has a pH greater than 4, preferably greater than 5, more preferentially greater than 6 or 6.5. The copolymer P generally has a pH of less than 13, preferably less than 12, more preferentially less than 11. In particular, the copolymer P has a pH ranging from 4 to 13 or from 4 to 12 or from 4 to 11, preferably ranging from 5 to 13 or from 5 to 12 or from 5 to 11, more preferentially ranging from 6 to 13 or from 6 to 12 or from 6 to 11, also more preferentially ranging from 6.5 to 13 or from 6.5 to 12 or from 6.5 to 11.

The copolymer P according to the invention can be used in many technical fields, particularly as a rheology control agent. It can be incorporated into different compositions. Thus, the invention provides a rheology control composition comprising at least one copolymer P according to the invention and water.

The rheology control composition according to the invention is particularly suitable for facilitating the use of pigments in an aqueous medium, in particular organic or mineral pigments. It can be incorporated into a specific pigment formulation. The invention thus provides an aqueous formulation comprising:
at least one rheology control composition according to the invention: optionally
at least one organic or mineral pigment or organic, organo-metallic or mineral particles, for example calcium carbonate, talc, kaolin, mica, silicates, silica, metal oxides, in particular titanium dioxide, iron oxides; and optionally
at least one agent chosen among a particle-spacer agent, a dispersing agent, a stabilising steric agent, an electrostatic stabilising agent, an opacifying agent, a colouring agent, a solvent, a coalescent agent, an anti-foaming agent, a preservative agent, a biocide, a spreading agent, a thickening agent, a film-forming copolymer and mixtures thereof.

Preferably, the formulation according to the invention is a coating formulation, in particular an ink formulation, a varnish formulation, an adhesive formulation, a paint formulation, for example a decorative paint or an industrial paint formulation.

The copolymer P according to the invention can also be used in the printing field, in particular textile printing. The invention thus provides a concentrated aqueous pigment pulp comprising at least one copolymer P according to the invention and at least one coloured organic or mineral pigment.

The invention also provides a method for controlling the viscosity of an aqueous composition that includes the addition of at least one copolymer P according to the invention to this composition. The viscosity control method according to the invention is used for an aqueous composition that is an aqueous formulation according to the invention. The advantageous, particular or preferred features of the copolymer P according to the invention define rheology control compositions, aqueous formulations, pigment pulp as well as viscosity control methods according to the invention which are also advantageous, particular or preferred.

The following examples illustrate the various aspects of the invention.

### EXAMPLES

### Example 1: preparation of copolymers P1, P2, P3 according to the invention

### Preparation of the compound (cl) according to the invention

In a first step, 17.8 g of toluene diisocyanate (TDI), 0.098 g of alloocimene, 0.255 g of titanium diisopropoxide bis(acetylacetonate) (Tyzor AA 105) and 39.1 g of ethyl acrylate (monomer b) are weighed into an Erlenmeyer flask.

Then, 13.3 g of ethylene glycol methacrylate (EGMA) and 7.1 g of ethyl acrylate (monomer b) are weighed into a dropping funnel. The contents of this funnel are poured into the Erlenmeyer flask over 20 minutes at a temperature below 35° C. and left to react for 30 minutes. The result is the compound (e1) (EGMA-TDI).

In a second step, 250 g of compound (d2a) (prepared by dimerisation by Guerbet reaction of a compound of formula I wherein R represents a straight C₅-alkyl group, m represents 0 and n represents 5 and of a compound of formula I wherein R represents a straight C₇-alkyl group, m represents 0 and n represents 4, ethoxylated 50 times-Isofol 2426S-50EO) are weighed into a 1,000 ml reactor and kept in the molten state at 65° C. The compound (e1) is then poured onto this compound (d2a) over 20 minutes at 65° C., then kept heated for 1 hour and 30 minutes. Lastly, the mixture is diluted with 57.98 g of monomer b (ethyl acrylate) and 167.98 g of deionised water to obtain a liquid at room temperature. The monomer (c1) is obtained from the compounds (d2a) and (e1) in ethyl acrylate (monomer b).

### Preparation of the compound (c2) according to the invention

200.0 g of compound (d2a) (Isofol2426S-50EO), 0.126 g of alloocimene and 12.02 g of methacrylic anhydride (compound e) are introduced into a glass reactor. The mixture is heated to 82° C.±2° C. over 2 hours and 30 minutes. At room temperature, the monomer (c2) obtained is then diluted with 133.38 g of monomer (a) (methacrylic acid) and 59.96 g of deionised water.

### Preparation and characterisation of the copolymer (P1) according to the invention

269 g of deionised water and 2.37 g of sodium dodecyl sulphate are introduced into a glass reactor.

120.6 g of monomer (a) (methacrylic acid), 148.5 g of monomer (b) (ethyl acrylate), 23.9 g of compound (cl), 2.43 g of sodium dodecyl sulphate and 258.7 g of deionised water are weighed into a first glass beaker.

In a second glass beaker, 0.318 g of ammonium persulphate are weighed and then dissolved in 5.6 g of deionised water.

10.42 g of monomer (h) (2-acrylamido-2-methylpropane sulphonic acid sodium salt) at 50% by weight in water are weighed into a third container, such as a disposable syringe. The contents of the reactor are heated to a temperature of 85° C.±2° C. The reagents from the 3 containers are introduced into the polymerisation reactor over 2 hours at a temperature of 85° C.±2° C.

0.224 g of ammonium persulphate dissolved in 22.4 g of deionised water are then added over 1 hour, with the temperature kept at 85° C.±2° C. Heating is continued for 1 hour before the medium is allowed to cool to room temperature.

The copolymer (P1) is obtained at 30.4% by weight of solids content, the composition of which is detailed in Table 1.

### Preparation and characterisation of the copolymer (P2) according to the invention

269 g of deionised water and 2.37 g of sodium dodecyl sulphate are introduced into a glass reactor.

120.6 g of monomer (a) (methacrylic acid), 148.5 g of monomer (b) (ethyl acrylate), 23.9 g of monomer (cl), 2.43 g of sodium dodecyl sulphate, 258.7 g of deionised water and 1.0 g of n-dodecyl mercaptan are weighed into a first glass beaker.

In a second glass beaker, 0.318 g of ammonium persulphate are weighed and then dissolved in 5.6 g of deionised water.

10.42 g of monomer (h) (2-acrylamido-2-methylpropane sulphonic acid sodium salt) at 50% by weight in water are weighed into a third container, such as a disposable syringe. The contents of the reactor are heated to a temperature of 85° C.±2° C.

The reagents from the 3 containers are introduced into the polymerisation reactor over 2 hours at a temperature of 85° C.±2° C.

0.224 g of ammonium persulphate dissolved in 22.4 g of deionised water are then added over 1 hour, with the temperature kept at 85° C.±2° C. Heating is continued for 1 hour before the medium is allowed to cool to room temperature.

A copolymer (P2) is obtained at 30.0% by weight of solids content, the composition of which is detailed in Table 1.

### Preparation and characterisation of the copolymer (P3) according to the invention

269 g of deionised water and 2.37 g of sodium dodecyl sulphate are introduced into a glass reactor.

120.6 g of monomer (a) (methacrylic acid), 148.5 g of monomer (b) (ethyl acrylate), 23.9 g of monomer (cl), 2.43 g of sodium dodecyl sulphate, 258.7 g of deionised water and 0.5 g of n-dodecyl mercaptan are weighed into a first glass beaker.

In a second glass beaker, 0.318 g of ammonium persulphate are weighed and then dissolved in 5.6 g of deionised water.

10.42 g of monomer (h) (2-acrylamido-2-methylpropane sulphonic acid sodium salt) at 50% by weight in water are weighed into a third container, such as a disposable syringe.

The contents of the reactor are heated to a temperature of 85° C.±2° C.

The reagents from the 3 containers are introduced into the polymerisation reactor over 2 hours at a temperature of 85° C.±2° C.

0.224 g of ammonium persulphate dissolved in 22.4 g of deionised water are then added over 1 hour, with the temperature kept at 85° C.±2° C. Heating is continued for 1 hour before the medium is allowed to cool to room temperature.

A copolymer (P3) is obtained at 30.2% by weight of solids content, the composition of which is detailed in Table 1.

### Preparation and characterisation of the copolymer (P4) according to the invention

260.7 g of deionised water and 2.49 g of sodium dodecyl sulphate are introduced into a glass reactor.

110.18 g of monomer a (methacrylic acid), 162.11 g of monomer b (ethyl acrylate), 30.3 g of compound (c2), 2.49 g of sodium dodecyl sulphate and 325 g of deionised water are weighed into a first glass beaker.

In a second glass beaker, 0.329 g of ammonium persulphate are weighed and then dissolved in 4 g of deionised water.

The contents of the reactor are heated to a temperature of 85° C.±2° C.

The reagents from the 2 containers are introduced into the polymerisation reactor over 2 hours at a temperature of 85° C.±2° C.

0.256 g of ammonium persulphate dissolved in 59 g of deionised water are then added over 1 hour, with the temperature kept at 85° C.±2° C. Heating is continued for 1 hour before the medium is allowed to cool to room temperature.

A copolymer (P4) is obtained at 30.0% by weight of solids content, the composition of which is detailed in Table 1

TABLE 1

| Copolymer | P1 | P2 | P3 | P4 |
|---|---|---|---|---|
| compound a (% by weight) | 40.45 | 40.45 | 40.45 | 36.42 |
| compound b (% by weight) | 49.79 | 49.79 | 49.79 | 53.58 |
| compound c (% by weight) | 8.02 | 8.02 | 8.02 | 10 |
| compound h (% by weight) | 1.75 | 1.75 | 1.75 | 0 |

### Example 2: Preparation and Characterisation of Aqueous Paint Formulations According to the Invention

By mixing the various ingredients under stirring, a matt paint formulation is prepared according to the invention. The compounds and amounts (g) used are listed in Table 2.

TABLE 2

| Ingredients in the matt paint formulation | Amount (g) |
|---|---|
| Ecodis P90 (Coatex dispersant) | 1.5 |
| Tego 825 (Tego anti-foaming agent) | 0.5 |
| Tiona 568 (Tronox TiO₂) | 35.05 |
| Omyacoat 850 OG (Omya CaCO₃) | 105.1 |
| Omyacarb 2 AV (Omya CaCO₃) | 160.15 |
| Acronal S790 (Basf binder) | 65.05 |
| Monopropylene glycol | 5 |
| Texanol (Eastman coalescent) | 5 |
| NH₄OH (28% in water) | 0.7 |
| Aqueous composition of copolymer P1 | 3.65 |
| according to the invention | |
| Water | 118.3 |
| Total | 500.00 |

The paint formulation is then coloured by adding 5% by weight of a black pigment (Colanyl N500 black by Clariant) to obtain the formulation F1 according to the invention. Similarly, the aqueous formulations F2 and F3 according to the invention are prepared by replacing the copolymer composition P1 respectively with the copolymer compositions P2 and P3 according to the invention.

Then, for each formulation F1, F2 and F3, the following are measured at 25° C.:
the Brookfield viscosity at 10 rpm (μB10, mPa·s);
the Brookfield viscosity at 100 rpm (μB100, mPas);
the Cone Plan viscosity or ICI viscosity, measured at high shear gradient (μI, mPa·s);
the Stormer viscosity, measured using the reference modulus at medium shear gradient (μS, Krebs Units or KUs).

The results are measured immediately after the addition of the black pigment (T=0) and measured 24 hours after this addition (T=24H). They are shown in Table 3.

The pigment compatibility of the formulations F1, F2 and F3 is assessed on a dry coat of paint. The colour of the initially white paint is obtained by adding 5% of black pigment-based colouring agent (Colanyl N500 black by Clariant); this percentage is calculated relative to the weight of the white paint formulation.

The rub-out test, which is known per se, involves using a finger to rub out coloured paint applied to a wet layer 150 micrometres thick on a contrast chart. This makes it possible to expose a small part of the surface finish of the layer of freshly applied coloured paint to a shear effect generated by a circular movement of the finger. The shear effect can change the stability and distribution of the coloured pigment in the matrix constituted by the layer of coloured paint and, consequently, the intensity of the colour in the sheared area. When the layer of coloured paint is dry, the difference in colour between the initially sheared area of the layer of coloured paint and the unsheared area of coloured paint is measured using a Byk Spectro-Guide Sphere Gloss spectrophotometer.

The colour difference is quantified by the ΔE value calculated from the measurement parameters corresponding to the known L*a*b* colour space. A low ΔE value indicates a reduced colour difference between the sheared and unsheared areas and therefore improved pigment compatibility.

The unsheared area of coloured paint is also measured against one of the L*a*b* colour space parameters. Parameter L* quantifies the intensity of the colour. A low L* value indicates reduced brightness and therefore greater black intensity, corresponding to improved pigment compatibility of the paint formulation being assessed in which the copolymer according to the invention is used. The results are shown in Table 3.

TABLE 3

| | | Formulation | | |
|---|---|---|---|---|
| Viscosity (mPa · s) | | F1 | F2 | F3 |
| μB10 | T = 0 | 41,000 | 8,840 | 29,000 |
| μB100 | | 4,640 | 1,708 | 3,740 |
| μS | | 119 | 89 | 106 |
| μI | | 110 | 70 | 85 |
| μB10 | T = 24 | 42,700 | 10,240 | 30,800 |
| μB100 | HRS | 5,070 | 1,896 | 3,920 |
| μS | | 122 | 91 | 109 |
| μI | | 105 | 70 | 85 |

Pigment compatibility

| | | | |
|---|---|---|---|
| ΔE | 2.09 | 1.35 | 1.91 |
| L* | 32.2 | 31.53 | 32.59 |

For the formulations F1, F2 and F3 according to the invention, the copolymers according to the invention make it possible to control the various components of the viscosity, both after preparation and over time. The copolymers according to the invention confer good pigment compatibility to these paint formulations.

1. A copolymer P prepared by a polymerisation reaction of an anionic monomer (a), an ester (b), and a compound (c),
wherein the anionic monomer (a) is at least one selected from the group consisting of acrylic acid, an acrylic acid salt, methacrylic acid, a methacrylic acid salt, and combinations thereof,
wherein the ester (b) is a C₁-C₈ ester of a compound derived from at least one acid chosen among selected from the group consisting of acrylic acid, methacrylic acid, maleic acid, itaconic acid, and crotonic acid; and
wherein the compound (c) is prepared by a reaction of a compound (d) and a compound (e),
wherein the compound (d) is obtained by:
dimerisation, by a Guerbet reaction, of two identical or different compounds of formula I: 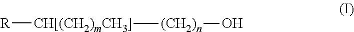
wherein:
R independently represents a straight C₄-C₉-alkyl group,
m independently represents 0 or 1, and
n independently represents a number ranging from 2 to 7; and
polyalkoxylation of the resulting dimer, and
of at least one wherein the compound (e) comprises a polymerisable group and another group reactive with the hydroxyl group of the compound (d).

2. The copolymer P of claim 1, wherein the anionic monomer (a) is at least one selected from the group consisting of acrylic acid, methacrylic acid, and combinations thereof.

3. The copolymer P of claim 1, wherein the ester (b) is at least one selected from the group consisting of a C₁-C₇ ester,
an acrylic acid ester, a methacrylic acid ester,
methyl acrylate, ethyl acrylate, propyl acrylate, butyl acrylate, ethyl hexyl acrylate, methyl methacrylate, ethyl methacrylate, propyl methacrylate, butyl methacrylate, ethyl hexyl methacrylate, and combinations thereof.

4. The copolymer P of claim 1,
wherein the dimerisation of two identical compounds of formula I results in a homodimer (d1), or
wherein the compound (d) is a homodimer (d1) obtained by dimerisation of two identical compounds of formula I wherein:
R represents a straight C₅-C₇-alkyl group,
m represents 0 or 1,
n represents a number ranging from 2 to 7, or
wherein the compound (d) is a homodimer (d1) obtained by dimerisation of two identical compounds of formula I wherein:
R represents a straight C₄-C₉-alkyl group,
m represents 0 or 1,
n represents a number ranging from 5 to 7.

5. The copolymer P of claim 1, in which;
wherein the dimerisation of two different compounds (d) of formula I results in a mixture comprising 2 different homodimers (d1) and a heterodimer (d2), or
wherein a mixture of compounds (d) is obtained by dimerisation of two different compounds of formula I wherein:
R independently represents a straight C₅-C₇-alkyl group,
m independently represents 0 or 1,
n independently represents a number ranging from 2 to 7, or
wherein a mixture of compounds (d) is obtained by dimerisation of two different compounds of formula I wherein:
R independently represents a straight C₄-C₉-alkyl group,
m independently represents 0 or 1,
n independently represents a number ranging from 5 to 7, or
wherein a mixture of compounds (d) comprises a heterodimer compound (d2) obtained by dimerisation of
a first compound of formula I wherein R represents a straight C₅-alkyl group, m represents 0, and n represents 5, and of
of a second different compound of formula I wherein R represents a straight C₇-alkyl group, m represents 0, and n represents 4; or
wherein a mixture of compounds (d) comprises:
a heterodimer compound (d2) obtained by dimerisation of
a first compound of formula I wherein R represents a straight C₅-alkyl group, m represents 0, and n represents 5, and of
a second different compound of formula I wherein R represents a straight C₇-alkyl group, m represents 0, and n represents 4,
a first homodimer (d1) obtained by dimerisation of a compound of formula I wherein R represents a straight C₅-alkyl group, m represents 0, and n represents 5, and
a second homodimer (d1) obtained by dimerisation of a different compound of formula I wherein R represents a straight C₇-alkyl group, m represents 02 and n represents 4.

6. The copolymer P of claim 1,
wherein the compound (d) comprises from 10 to 150 alkoxylations, or
wherein the compound (d) is polyethoxylated, polyethoxylated-polypropoxylated, or polyethoxylated-polybutoxylated, or
wherein the compound (d) comprises from 10 to 150 ethoxylations.

7. The copolymer P according of claim 1,
wherein the polymerisable group of the compound (e) is a terminal ethylene group, or
wherein the compound (e) is at least one selected from the group consisting of acrylic acid, methacrylic acid, maleic acid, itaconic acid, crotonic acid, acrylic anhydride, methacrylic anhydride, maleic anhydride, itaconic anhydride, a styrylyl-isocyanate a methacrylate-alkylene-isocyanate, and combinations thereof, or
wherein the compound (e) is prepared by a prior reaction of a diisocyanate compound and at least one compound selected from the group consisting of ethylene glycol acrylate, ethylene glycol methacrylate, isoprenol, ethylene glycol vinyl, allyl alcohol, methallyl alcohol, hydroxybutyl vinyl ether, and combinations thereof.

8. The copolymer P claim 1, wherein the polymerisation reaction comprises:
from 20 to 74.9% by weight of monomer (a), or
from 25 to 79.9% by weight of monomer (b), or
from 0.1 to 55% by weight of monomer (c),
each relative to the total amount by weight of monomers (a), (b), and (c).

9. The copolymer P of claim 1, wherein the polymerisation reaction further comprises:
a cross-linking monomer (f), or
a monomer (f) comprising at least two olefinic unsaturations, or
a hydrophobic monomer (g) different from compound (c),
at least one compound (h) selected from the group consisting of 2-acrylamido-2-methylpropane sulphonic acid, ethoxymethacrylate sulphonic acid, sodium methallyl sulphonate, styrene sulphonate hydroxyethyl acrylate phosphate, hydroxypropyl acrylate phosphate, hydroxyethylhexyl acrylate phosphate, hydroxyethyl methacrylate phosphate, hydroxypropyl methacrylate phosphate, hydroxyethylhexyl methacrylate phosphate, their salts and combinations thereof, or
at least one compound (i) selected from the group consisting of hydroxyethyl acrylate, hydroxypropyl acrylate, hydroxyethylhexyl acrylate, hydroxyethyl methacrylate, hydroxypropyl methacrylate, and hydroxyethylhexyl methacrylate.

10. The copolymer P of claim 1, which is fully neutralized, partially neutralised, fully coacervated, or partially coacervated.

11. An aqueous solution comprising the copolymer P of claim 1 dissolved in water,
wherein the aqueous solution has:
a pH greater than 4, or
a pH of less than 13 or
a pH ranging from 4 to 13.

12. A rheology control composition comprising the copolymer P of claim 1 and water.

13. An aqueous formulation comprising
the rheology control composition of claim 12.

14. The aqueous formulation of claim 13, which is an ink formulation, a varnish formulation, an adhesive formulation, or a paint formulation.

15. A concentrated aqueous pigment pulp, comprising the copolymer P of claim 1 and at least one selected from the group consisting of a coloured organic pigment and a coloured mineral pigment.

16. A method for controlling the viscosity of an aqueous composition, the method comprising adding the copolymer P of claim 1 to the aqueous composition to produce an aqueous composition with a controlled viscosity comprising the copolymer P.

17. The method of claim 16, wherein the aqueous formulation with the controlled viscosity further comprises at least one selected from the group consisting of an organic pigment, a mineral pigment, an organic particle, an organo-metallic particle, a mineral particle, a particle-spacer agent, a dispersing agent, a stabilising steric agent, an electrostatic stabilising agent, an opacifying agent, a colouring agent, a solvent, a coalescent agent, an anti-foaming agent, a preservative agent, a biocide, a spreading agent, a thickening agent, a film-forming copolymer, and mixtures thereof.

18. The aqueous formulation of claim 13, further comprising at least one selected from the group consisting of an organic pigment, a mineral pigment, an organic particle, an organo-metallic particle, a mineral particle, a particle-spacer agent, a dispersing agent, a stabilising steric agent, an electrostatic stabilising agent, an opacifying agent, a colouring agent, a solvent, a coalescent agent, an anti-foaming agent, a preservative agent, a biocide, a spreading agent, a thickening agent, a film-forming copolymer, and mixtures thereof.
